(19) United States
(12) Patent Application Publication
(10) Pub. No.: US 2010/0053391 A1
(43) Pub. Date: Mar. 4, 2010

(54) MINIATURIZED IMAGE CAPTURING DEVICE AND METHOD FOR ASSEMBLING THE SAME

(75) Inventor: Tzai-Kun HUANG, Taipei City (TW)

Correspondence Address: ROGER H. CHU, 19499 ERIC DRIVE, SARATOGA, CA, 95070, US

(73) Assignee: APPLE CREATIVE PRODUCTS, INC. (TAIWAN), Taipei (TW)

(21) Appl. No.: 12/547,673

(22) Filed: Aug. 26, 2009

Related U.S. Application Data
(60) Provisional application No. 61/092,277, filed on Aug. 27, 2008.

(51) Int. Cl. H04N 5/335; H04N 5/225; B23P 11/00

(52) U.S. Cl. 348/294; 29/505; 348/E05.091; 348/340; 348/E05.022

(57) ABSTRACT

A miniaturized image capturing device comprises: a lens base, which has a first open and a second open; at least one light source, which is disposed on a first PCB and around the periphery of the first open; at least one lens, which is accommodated in the lens base and close to the first open; a lens holder, which is accommodated in the lens base for holding the lens; at least one image sensor, which is accommodated in the lens base and close to the second open, the image sensor having an imaging region therein; and a PCB, which is electrically connected to the image sensor through a plurality of sensor signal pads.

### CROSS REFERENCE TO RELATED APPLICATION

This application claims priority from a co-pending U.S. Provisional Patent Application Ser. No. 61/092,277 filed Aug. 27, 2008, the entire content of which is incorporated herein by reference.

### FIELD OF THE INVENTION

The present invention generally relates to a miniaturized image capturing device and a method for assembling the same, more particularly to an image capturing device which adopts a linear arrangement in order to integrate all necessary elements as a lens, a lens holder, a lens base, light sources, a image sensor, and a PCB (printed circuit board) for providing light and capturing images.

### BACKGROUND OF THE INVENTION

With reference to FIG. 1, which illustrates an exploded view of a prior US patent application with the publication number of US 20080111707. The optical sensor module 100 of the patent application includes a PCB 110, a lens 120 disposed on a pad 111 of the PCB 110, a plurality of light sources 130 disposed around the lens 120 and a housing 150 having an image sensor 140 which is closely attached to the bottom surface of the pad 111. The PCB 110 is formed of a single-sided or double-side flexible printed circuit board (FPCB), in which the pad 111 and a substrate connection portion 113 are respectively formed to extend from both sides of a substrate 112 formed of a flexible material. In the PCB 110, a socket-type connector 114 is mounted on the substrate portion 113 such that the PCB 100 is connected to an external device. The lens 120 is closely attached to the top surface of the pad 111 such that a perforated portion 111a formed in the center of the pad 111 is covered by the lens 120. The image sensor 140 is inserted into a through hole 150a formed in the central portion of the housing 150 so as to be more reliably fixed to the bottom surface of the pad 111.

As it can be seen, the prior art has some more elements and larger volume, normally it is larger than 5×5 mm². The socket-type connector 114 has many pins, which are for the signals of R, G, B, array X, array Y, etc. Such arrangement is very complicate, and each pin is very thin and short, hence many kinds of problems can be caused, for instance, short, wrong connections while the connector is installed on a PCB, etc. Further that, such output signals are digital. In other words, the prior art is not good in the field of endoscopy. Since the digital signal is not as good as the analog signal in the aspect of DCC, video, etc. So, how to minimize the volume, decrease the amount of elements and the cost of assembling and approach better effect while transmitting signals is the most concern for the people skilled to the art.

### BRIEF SUMMARY OF THE INVENTION

The primary objective of the present invention is to provide a miniaturized image capturing device for integrating all necessary elements, so that multiple functions can be worked by the image capturing device while in endoscopy.

The second objective of the present invention is to provide the miniaturized image capturing device which is manufactured by the way of assembling all necessary elements on a flexible PCB via SMT (surface mounting technology). Hence, the cost of assembling will be highly decreased.

The present invention discloses the miniaturized image capturing device comprises: a lens base, which has a first open and a second open; at least one light source, which is disposed on a first PCB 309 and around the periphery of the first open; at least one lens, which is accommodated in the lens base and close to the first open; a lens holder, which is accommodated in the lens base for holding the lens; at least one image sensor, which is accommodated in the lens base and close to the second open, the image sensor having an imaging region therein; and a PCB, which is electrically connected to the image sensor through a plurality of sensor signal pads.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates an exploded view of a prior US patent application with the publication number of US 20080111707;

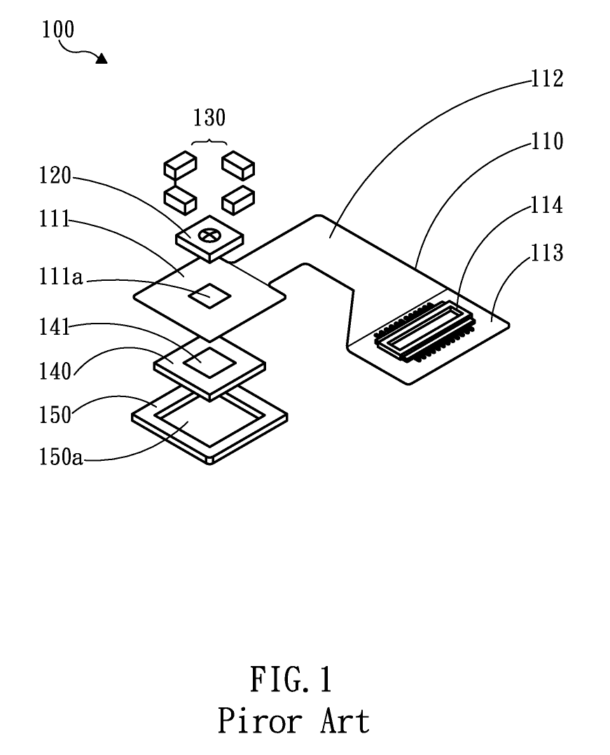

FIG. 2 illustrates a schematic sectional view of a miniaturized image capturing device of the present invention;

FIG. 3 illustrates a partially exploded 3-D view of the miniaturized image capturing device of the present invention;

FIG. 4 illustrates an assembled 3-D view of the miniaturized image capturing device of the present invention;

FIG. 5 illustrates a schematic assembled 3-D view of the relationships among the image sensor, two light sources and the PCB of the miniaturized image capturing device of the present invention;

FIG. 6 illustrates a schematic sectional view of FIG. 5;

FIG. 7A to FIG. 7E illustrate a plurality of views of assembling the miniaturized image capturing device of the present invention; and

FIG. 8 illustrates a flow chart of the method for assembling the miniaturized image capturing device of the present invention.

### DETAILED DESCRIPTION

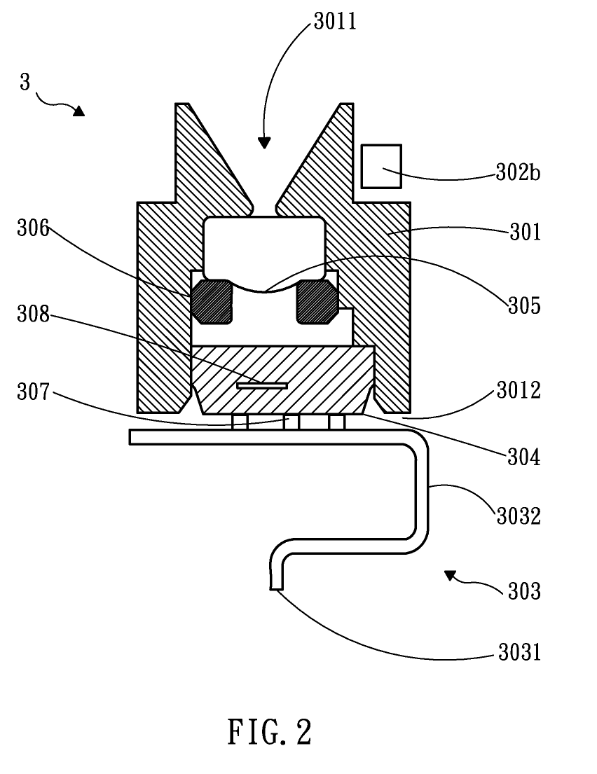

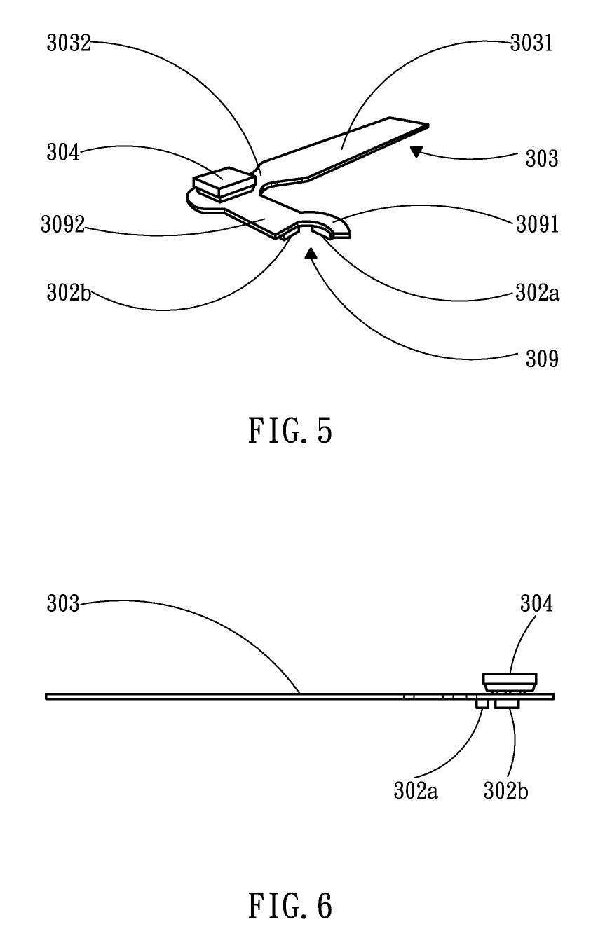

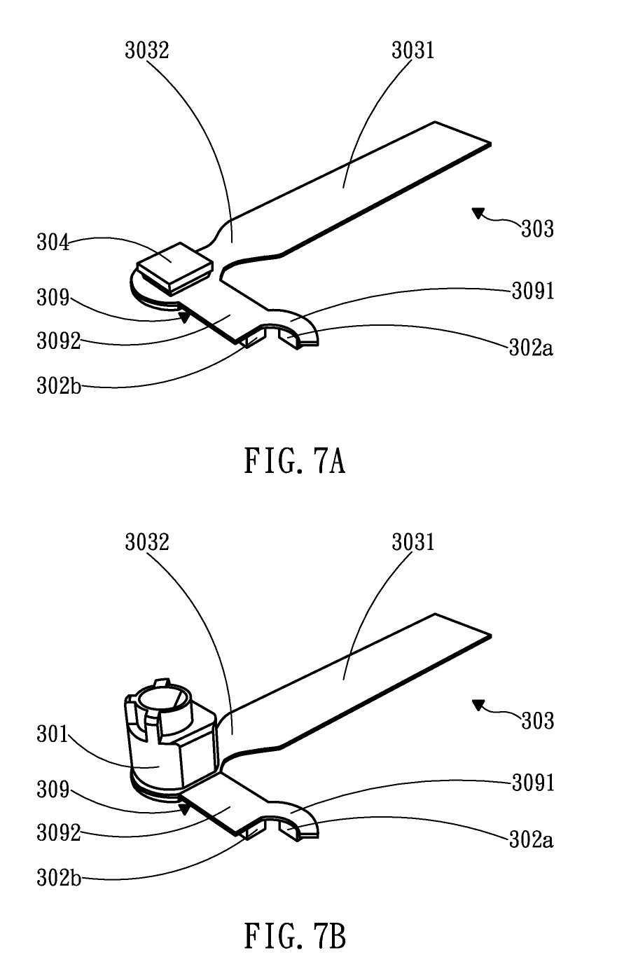

With reference to FIG. 2 to FIG. 6, which illustrate a schematic sectional view of a miniaturized image capturing device of the present invention, a partially exploded 3-D view of the miniaturized image capturing device of the present invention, an assembled 3-D view of the miniaturized image capturing device of the present invention, a schematic assembled 3-D view of the relationships among the image sensor, two light sources and the PCB of the miniaturized image capturing device of the present invention, and a schematic sectional view of FIG. 5. The present invention discloses the miniaturized image capturing device 3, which includes: a lens base 301, which is roughly a cylindrical shape with a first open 3011 and a second open 3012; two light sources 302a and 302b, which are disposed on a first PCB 309 with a folded portion 3092 and an arc portion 3091 and around the periphery of the first open 3011; one lens 305, which is accommodated in the lens base 301 and close to the first open 3011; a lens holder 306, which is accommodated in the lens base 301 for holding the lens 305; an image sensor 304, which is accommodated in the lens base 301 and close to the second open 3012, the image sensor 304 has an imaging region 308 therein; and a second PCB 303, which has a linear portion 3031 and a folded portion 3032 and is electrically connected to the image sensor 304 through a plurality of sensor signal pads 307; wherein the second PCB 303 and the first PCB 309 can be integrated as one member and vertically disposed with each other, the first open 3011 and the second open 3012 are disposed linearly along the axial direction of the lens base 301, the lens 305 and the image sensor 304 are orderly disposed between the first open 3011 and the second open 3012.

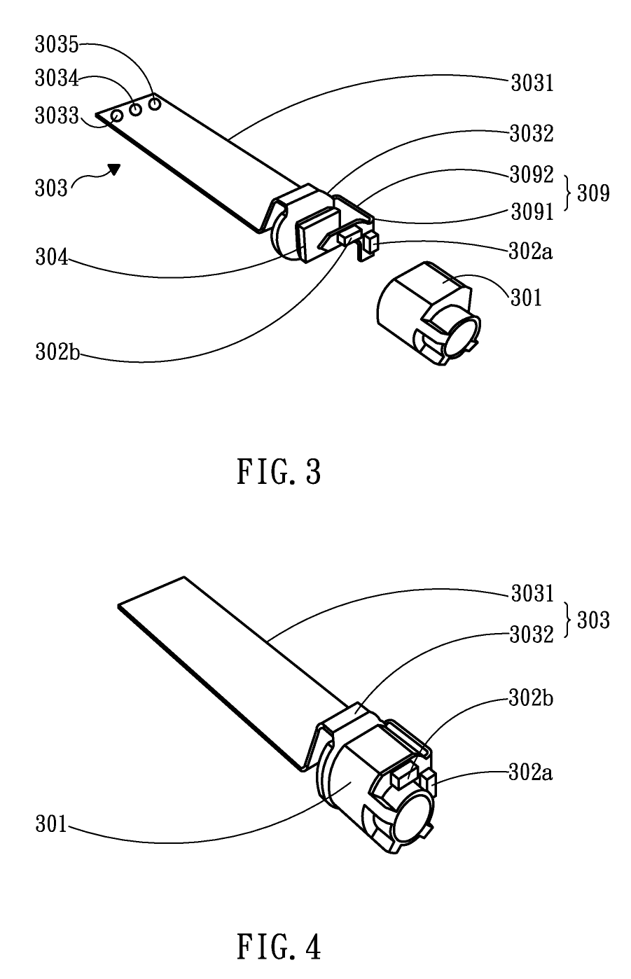

With reference to FIG. 3, there are three electrical pads 3033, 3034 and 3035, which are for the signals of DCC, video and ground and less than the output pins of prior arts. And the present invention is able to match with the two systems, NTSC and PAL, so that the present invention is more applicable.

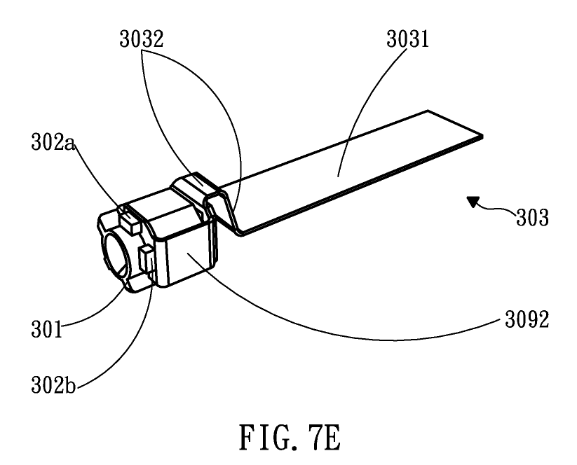

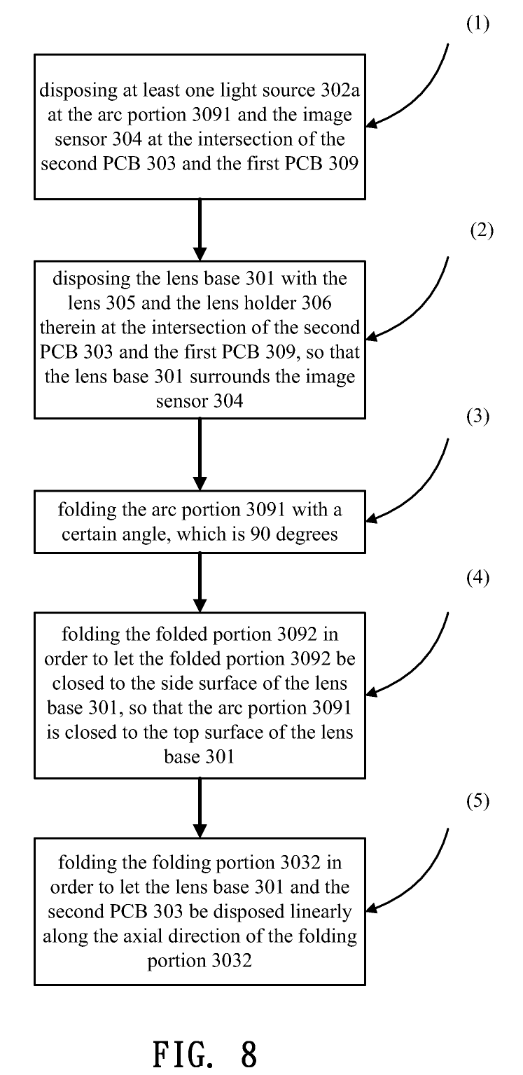

With references to FIG. 7A to FIG. 7E and FIG. 8, which illustrate a plurality of views of assembling the miniaturized image capturing device of the present invention and a flow chart of the method for assembling the miniaturized image capturing device of the present invention. As shown in FIG. 8, the method for assembling the miniaturized image capturing device comprises the steps of: (1) disposing at least one light source 302a at the arc portion 3091 and the image sensor 304 at the intersection of the second PCB 303 and the first PCB 309, as shown in FIG. 7A; (2) disposing the lens base 301 with the lens 305 and the lens holder 306 therein at the intersection of the second PCB 303 and the first PCB 309, so that the lens base 301 surrounds the image sensor 304, as shown in FIG. 7B; (3) folding the arc portion 3091 with a certain angle, which is 90 degrees, as shown in FIG. 7C; (4) folding the folded portion 3092 in order to let the folded portion 3092 be closed to the side surface of the lens base 301, so that the arc portion 3091 is closed to the top surface of the lens base 301, as shown in FIG. 7D; and (5) folding the folding portion 3032 in order to let the lens base 301 and the second PCB 303 be disposed linearly along the axial direction of the folding portion 3032, as shown in FIG. 7E.

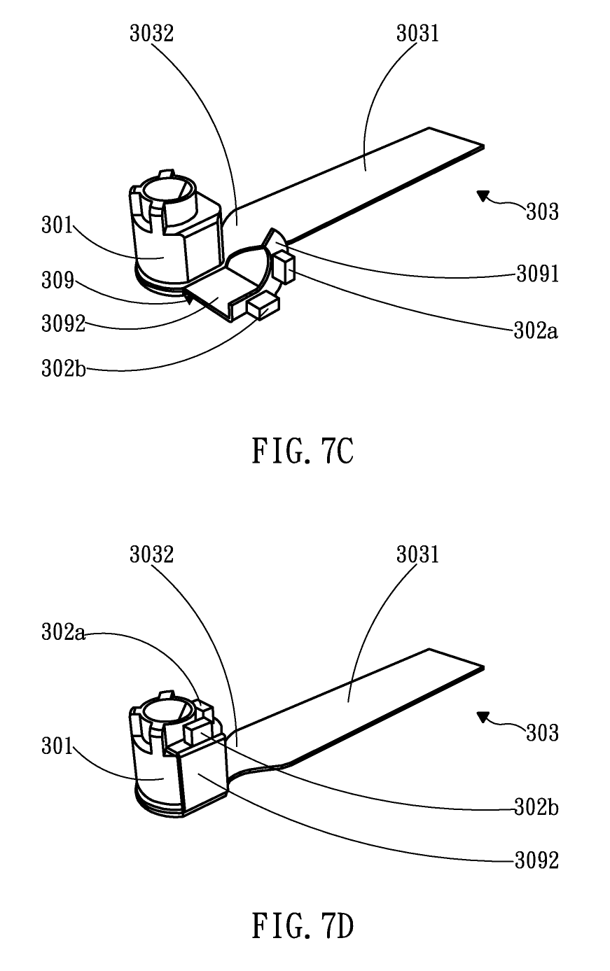

As shown in FIG. 6, the present invention is very thin and featuring its elasticity due to the second PCB 303, since the arrangement of the whole elements is linear. Such arrangement is totally different than the prior arts and more applicable.

As a conclusion, firstly, the output signals of the present invention are only three kinds of DCC, video and ground. Therefore the output signals are purified. More, they are analog. Secondly, the linear arrangement is just suitable to ergonomics while in a medical treatment. More than that, the total volume is less than 5×5 mm². Therefore, the present invention may achieve the demands while in the aspects of assembling and endoscopy.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A miniaturized image capturing device comprising:
a lens base, which has a first open and a second open;
at least one light source, which is disposed on a first PCB and around the periphery of the first open;
at least one lens, which is accommodated in the lens base and close to the first open;
at least one image sensor, which is accommodated in the lens base and close to the second open, the image sensor having an imaging region therein; and
a second PCB, which is electrically connected to the image sensor through a plurality of sensor signal pads;
wherein the first open and the second open are disposed linearly along the axial direction of the lens base, the lens and the image sensor being orderly disposed between the first open and the second open.

2. The miniaturized image capturing device according to claim 1, wherein the lens base is a cylindrical shape.

3. The miniaturized image capturing device according to claim 1, wherein the first PCB has a folded portion and an arc portion.

4. The miniaturized image capturing device according to claim 1, wherein a lens holder is accommodated in the lens base for holding the lens.

5. The miniaturized image capturing device according to claim 1, wherein the second PCB has a linear portion and a folded portion.

6. The miniaturized image capturing device according to claim 1, wherein the second PCB and the first PCB can be integrated as one member and vertically disposed with each other.

7. A method for assembling a miniaturized image capturing device comprising the steps of:
(1) disposing at least one light source at the arc portion and the image sensor at the intersection of the second PCB and the first PCB;
(2) disposing the lens base with the lens and the lens holder therein at the intersection of the second PCB and the first PCB, so that the lens base surrounds the image sensor;
(3) folding the arc portion with a certain angle;
(4) folding the folded portion in order to let the folded portion be closed to the side surface of the lens base, so that the arc portion is closed to the top surface of the lens base; and
(5) folding the folding portion in order to let the lens base and the second PCB be disposed linearly along the axial direction of the folding portion.

8. The method for assembling the miniaturized image capturing device according to claims 7, wherein the certain angle of step (3) is 90 degrees.
